(19) United States
(12) Patent Application Publication
(10) Pub. No.: US 2015/0146565 A1
(43) Pub. Date: May 28, 2015

(54) METHOD AND APPARATUS FOR DOWNLINK TRANSMISSION IN A CLOUD RADIO ACCESS NETWORK

(71) Applicants: Wei Yu, Toronto (CA); Pratik Narendra Patil, Toronto (CA); Mohammadhadi 8aligh, Kanata (CA)

(72) Inventors: Wei Yu, Toronto (CA); Pratik Narendra Patil, Toronto (CA); Mohammadhadi 8aligh, Kanata (CA)

(21) Appl. No.: 14/555,249

(22) Filed: Nov. 26, 2014

Related U.S. Application Data
(60) Provisional application No. 61/910,028, filed on Nov. 27, 2013.

(51) Int. Cl. H04W 72/04; H04W 24/10

(52) U.S. Cl. CPC H04W 72/042; H04W 24/10
USPC 370/253; 370/329

(57) ABSTRACT

Various disclosed embodiments include methods and systems of downlink transmission in a cloud radio access network (CRAN). The method comprises identifying, by a data processing system, a mobile station (MS) coupled to the CRAN to participate in a data compression downlink transmission scheme. The method comprises identifying, by the data processing system, an MS coupled to the CRAN to participate in a data sharing downlink transmission scheme.

### CROSS-REFERENCE TO RELATED APPLICATIONS

The present application claims priority to U.S. provisional Application No. 61/910,028 entitled “METHOD AND APPARATUS FOR DOWNLINK TRANSMISSION IN A CLOUD RADIO ACCESS NETWORK” filed on Nov. 27, 2013, which is incorporated herein by reference.

### TECHNICAL FIELD

The present disclosure is generally directed to downlink transmissions in a wireless communications network, such as a cloud-based radio access network (CRAN).

### BACKGROUND

Interference management is known to be an obstacle in realizing the spectral efficiency increase promised by multiple-antenna techniques in wireless systems. To address this problem, CRAN architectures have been considered in which base stations (BSs) are connected via high speed digital backhaul links to centralized cloud computing servers, where the encoding functionalities and the decoding functionalities of the base stations are migrated, which enables efficient resource allocation and interference management.

By allowing coordination and joint signal processing across multiple base stations (BSs) in the network, the CRAN architecture enables the implementation of network multiple-input multiple-output (MIMO) or coordinated multi-point (CoMP) concepts. However, one of the main impairments to the implementation of CRAN architectures is given by the capacity limitations of the digital backhaul links connecting the base stations and the central unit, which limits efficient interference management.

The present disclosure provides various methods, mechanisms, and techniques to efficiently manage interference in and to increase throughput of a CRAN-based multi-cell network.

### SUMMARY

According to one embodiment, there is provided a method of downlink transmission in a cloud radio access network (CRAN) performed by a data processing system. The method comprises identifying, by the data processing system, a mobile station (MS) coupled to the CRAN to participate in a data compression downlink transmission scheme. The method comprises identifying, by the data processing system, an MS coupled to the CRAN to participate in a data sharing downlink transmission scheme.

In another embodiment, there is provided a data processing system for downlink transmission in a cloud radio access network (CRAN). The data processing system comprises a processor, and memory coupled to the processor. The memory comprises instructions that, when executed by the processor, cause the data processing system to perform operations comprising identifying a mobile station (MS) coupled to the CRAN to participate in a data compression downlink transmission scheme, and identifying an MS in the CRAN to participate in a data sharing downlink transmission scheme.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a message sharing cooperation scheme for downlink transmission in a cloud radio access network (CRAN) architecture;

FIG. 2 illustrates an example of a compression-based cooperation scheme for downlink transmission in a cloud radio access network (CRAN) architecture;

FIG. 3 illustrates an example of a hybrid compression and message sharing cooperation scheme for downlink transmission in a cloud radio access network (CRAN) architecture according to one embodiment;

FIG. 4 illustrates a flow diagram illustrating hybrid compression and message sharing according to one embodiment;

FIG. 5 illustrates a graphical representation of a comparison of cumulative distribution functions of user rates for the message sharing, compression-based, and hybrid cooperation schemes according to one embodiment;

FIG. 6 illustrates a graphical representation of a comparison of average per-cell sum rate of the hybrid scheme to the compression-based scheme as a function of average per-cell backhaul capacity according to one embodiment;

FIG. 7 illustrates a graphical representation of a comparison of cumulative distribution functions of user rates for the hybrid scheme and the compression-based scheme according to one embodiment;

FIG. 8 illustrates a flow diagram illustrating a method of downlink transmission in a cloud radio access network (CRAN) architecture according to one embodiment;

FIG. 9 illustrates an example communication system for downlink transmission in a cloud radio access network (CRAN) architecture according to one embodiment; and

FIGS. 10A, 10B and 10C illustrate example devices that can implement downlink transmission in a cloud radio access network (CRAN) architecture according to one embodiment.

### DETAILED DESCRIPTION

The interference mitigation capability of CRAM stems from its ability to jointly encode the user messages from across multiple BSs. One way to enable such joint pre-coding is to simply share each user's message with multiple BSs over the backhaul links. This backhaul transmission strategy, called message-sharing in the present disclosure, can be thought of as analogous to a decode-and-forward relaying strategy. As the sharing of each user's message across the entire network would require an excessively large amount of backhaul capacity, practical implementation of message-sharing often involves clustering, where each user selects a subset of cooperating BSs.

As an alternative strategy, the joint pre-coding of user messages can also be performed at the cloud server, rather than at the individual BSs. In this case, the pre-coded analog signals are compressed and forwarded to the corresponding BSs over the finite-capacity backhaul links for direct transmission by the BS antennas. This approach, called pure compression in the present disclosure, is akin to a compress-and-forward relaying strategy.

Instead of solely using either pure compression or pure message-sharing, disclosed embodiments include a hybrid scheme that can benefit overall system performance. Disclosed embodiments include processes where a data processing system that comprises a central processor or cloud server directly sends messages for some of the users to one or more of the BSs along with the compressed version of the rest of the pre-coded signal (e.g., sending a “clean” message for strong users while compressing the rest of the interference canceling signals). One skilled in the art will appreciate that in some embodiments it is possible to send a message both directly to one or more of the BSs along with a compressed version of the same message along with other messages in the pre-coded signal. It is also possible for parts of a message to be compressed with other parts sent directly.

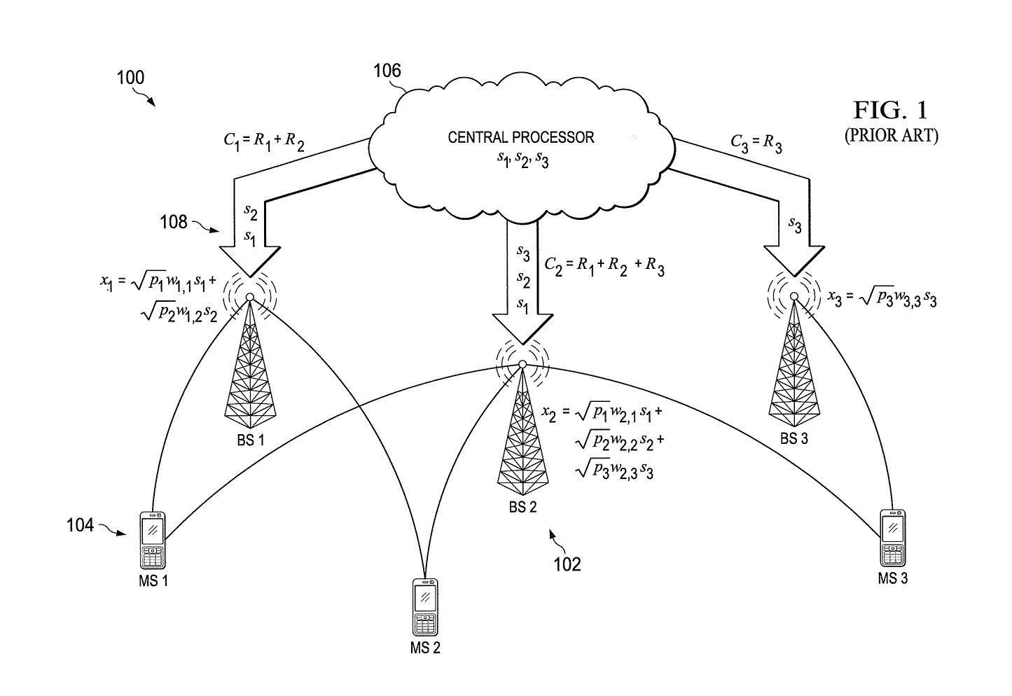

FIG. 1 illustrates an example of a message sharing cooperation scheme for downlink transmission in a cloud radio access network (CRAN) architecture. As illustrated in FIG. 1, a network MIMO (multiple input multiple output) system 100 includes L single antenna base stations (BSs) 102 serving K single antenna mobile stations (MSs) 104. Each of the BSs 102 is coupled to a central processor (CP) 106 via a capacity limited digital backhaul link 108. In some embodiments, the central processor 106 comprises a data processing system that includes a centralized baseband processing unit pool. A sum-capacity backhaul constraint may be imposed so that the total capacity over the L backhaul links is limited to C bits per channel use. The sum-capacity backhaul constraint is adopted in the present disclosure for convenience because it can model the scenario where the backhaul is implemented in a shared (e.g., wireless) medium. Alternatively or additionally, individual backhaul capacity constraints can also be imposed on each of the L backhaul links.

An independent data stream is transmitted from the central processor to each user. Let xₗ be the signal transmitted by BS l. The received signal at user k can be written as yₖ=hₖ^{H}x+zₖ, k=1, 2, . . . , K where xε [symbol] ^{L×1}=[x₁, . . . , x_{L}]^{T} is the aggregate signal from the L BSs, hₖε [symbol] ^{L×1}=[h_{1,k}, . . . , h_{L,k}] is the channel from the L BSs to the user k, and zₖ is the additive zero-mean Gaussian noise with variance σ². In addition, each BS l has a power constraint Pₗ so that E|Xₗ|²<Pₗ, l=1, 2, . . . , L.

The present disclosure describes processes that find the optimal encoding and transmission schemes at the central processor 106 and at the BSs 102 that maximize the weighted sum rate of the overall network. Fixed user scheduling is assumed in some embodiments of the present disclosure. In addition, perfect channel state information (CSI) is assumed to be available both at the central processor and at all the BSs in some cases.

### Message Sharing Scheme

Message sharing refers to the cooperation scheme in which the central processor 106 distributes the actual message of each user 104 to its cooperating BSs 102 through the backhaul links 108. Each BS 102 then forms a pre-coded signal based on all the user messages available to it, as shown in FIG. 1. Let sₖ be the message signal for user k, assumed to be complex Gaussian with zero-mean and unit variance. Let the normalized beamforming vector from all the BSs to user k be wₖε [symbol] ^{L×1}=[w_{1,k}, w_{2,k}, . . . , w_{L,k}] where w_{l,k} denote the component of the beamformer at BS l. Note that if BS l does not participate in cooperatively transmitting to user k, then w_{l,k}=0. The transmitted vector signal x from all the BSs can be written as

$$x = {\sum }_{k = 1}^{K} \sqrt{{p}_{k}} {w}_{k} {s}_{k} ,$$

where pₖ is the power of beam wₖ.

At the receiver, the signal-to-noise-interference-ratio (SINR) for user k can be expressed as

$${SINR}_{k} = \frac{{p}_{k} {\vert {h}_{k}^{H} {w}_{k} \vert}^{2}}{{\sum }_{j \neq k} {p}_{j} {\vert {h}_{k}^{H} {w}_{j} \vert}^{2} + {σ}^{2}} .$$

The achievable rate for user k can be modeled as Rₖ=log(1+SIN Rₖ), or using a similar expression based on coding and modulation format.

The question of which subset of BSs should serve each user is in general nontrivial. For comparison purpose, the present disclosure uses the following common heuristics for evaluating the achievable rates using the message-sharing scheme, wherein each user forms a cooperating cluster including S BSs with the strongest channels. Under a fixed BS cooperation structure, locally optimal beamformers for maximizing the weighted sum rate subject to BS power constraints can be found using the weighted minimum mean square error (WMMSE) approach. The total amount of backhaul required to support this message-sharing scheme can be calculated based on the achieved user rates multiplied by the number of BSs serving each user.

### Compression-Based Scheme

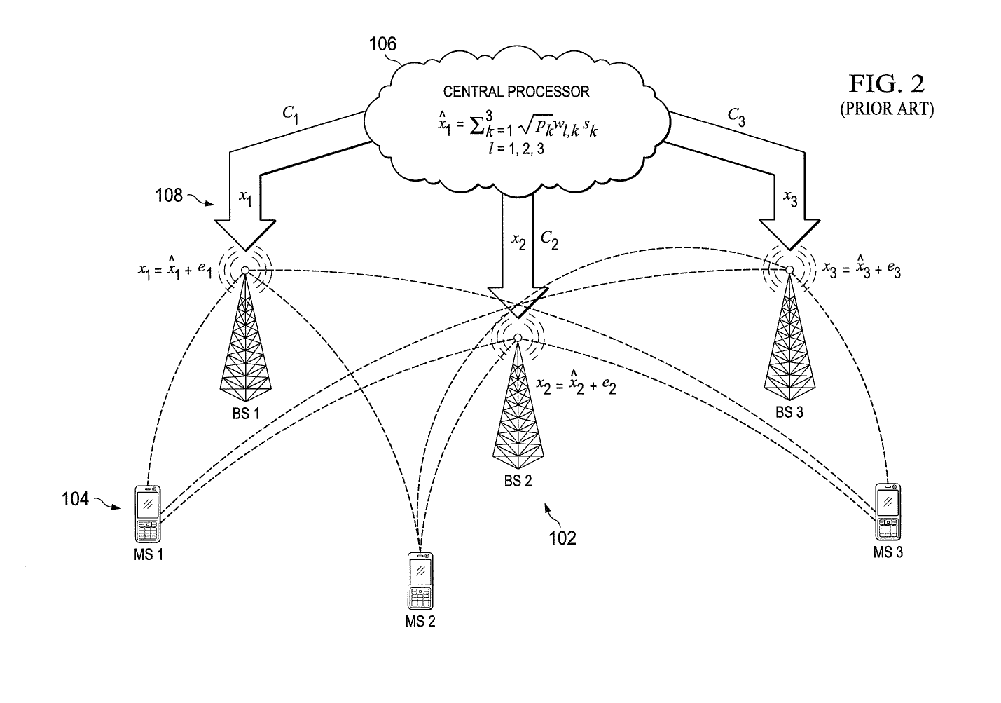

In a compression-based scheme, the functionality of pre-coding is completely migrated to the central processor 106, as shown in FIG. 2. The central processor 106 performs joint encoding of the user messages and forms the analog signals intended to be transmitted by the BSs' antennas to the MSs 104. As the pre-coded signals are analog, they need to be compressed before they can be forwarded to the corresponding BSs 102 through the finite-capacity backhaul links 108. Compression introduces quantization noises. The quantization noise level is a function of the backhaul capacity.

Let \hat{x}ε [symbol] ^{L×1}=[\hat{x}₁, . . . , \hat{x}_{L}]^{T} denote pre-coded signals intended for BSs 1 to L, which is formed using the beamformers for users 1 to K, i.e., wₖε [symbol] ^{L×1}=[w_{1,k}, w_{2,k}, . . . , w_{L,k}] with power pₖ:

$$\hat{x} = {\sum }_{k = 1}^{K} \sqrt{{p}_{k}} {w}_{k} {s}_{k} .$$

The power of \hat{x}ₗ is denoted as \hat{P}ₗ. The quantization process for \hat{x} can be modeled as x=\hat{x}+e, where e is the quantization noise with covariance Qε [symbol] ^{L×L} modeled as a Gaussian process and assumed to be independent of \hat{x}. In this case, the received SIN R for user k is

$${SINR}_{k} = \frac{{p}_{k} {\vert {h}_{k}^{H} {w}_{k} \vert}^{2}}{{\sum }_{j \neq k} {p}_{j} {\vert {h}_{k}^{H} {w}_{j} \vert}^{2} + {σ}^{2} + \vert {h}_{k}^{H} {Qh}_{k} \vert} .$$

The achievable rate for user k is again Rₖ=log(1+SIN Rₖ), or determined using a similar expression based on coding and modulation format. For simplicity, the present disclosure assumes independent quantization at each BS 102, in which case Q is a diagonal matrix with diagonal entries q₁. Assuming an ideal quantizer, the quantization noise level ql and the backhaul capacity Cl are related as

$$log ( \frac{{\hat{P}}_{l} + {q}_{l}}{{q}_{l}} ) \leq {C}_{l}$$

or using a similar expression based on the quantization method.

The optimization of the pure-compression strategy can now be stated as a weighted sum rate maximization problem over the transmit beamformers and the quantization noise levels as follows:

$${maximize}_{{w}_{k} , {p}_{k} , {q}_{l} , {C}_{l}} {\sum }_{k = 1}^{K} {μ}_{k} {R}_{k}$$

$$subject to log ( \frac{{\hat{P}}_{l} + {q}_{l}}{{q}_{l}} ) \leq {C}_{l} , 1 \leq l \leq L$$

$${\sum }_{l = 1}^{L} {C}_{l} \leq C$$

$${\hat{P}}_{l} + {q}_{l} \leq {P}_{l} , 1 \leq l \leq L$$

$${C}_{l} \geq 0 , 1 \leq l \leq L . \\ ( optimization problem ( P 1 ) ) ,$$

where Rₖ and \hat{P}ₗ are both functions of the underlying variables wₖ, pₖ. This may be referred to as optimization problem (P1).

### Hybrid Compression and Message Sharing

In the message-sharing based cooperation scheme, the backhaul links 108 are used to carry user messages. The advantage of such an approach is that BSs 102 get “clean” messages which they can use for joint encoding. However, the backhaul capacity constraint limits the cooperation cluster size for each user. In the compression-based scheme, the pre-coding operation is exclusively performed at the central processor 106. The main advantage of such an approach is that, because the central processor 106 has access to all the user data, it can form a joint pre-coding vector using all the user messages, thus achieving full BS cooperation. Additionally, the BSs 102 can now be completely oblivious of the user codebooks as the burden of pre-processing is shifted from the BSs 102 to the central processor 106. However, because the pre-coded signals are compressed, quantization noise is increased.

The present disclosure includes a hybrid compression and message sharing process in which the pre-coding operation is split between the central processor 106 and the BSs 102. Because the desired pre-coded signal typically includes both strong and weak users, it may be beneficial to send clean messages for the strong users, rather than including them as a part of the signal to be compressed. In so doing, the amplitude of the signal that needs to be compressed can be lowered, and the required number of compression bits reduced.

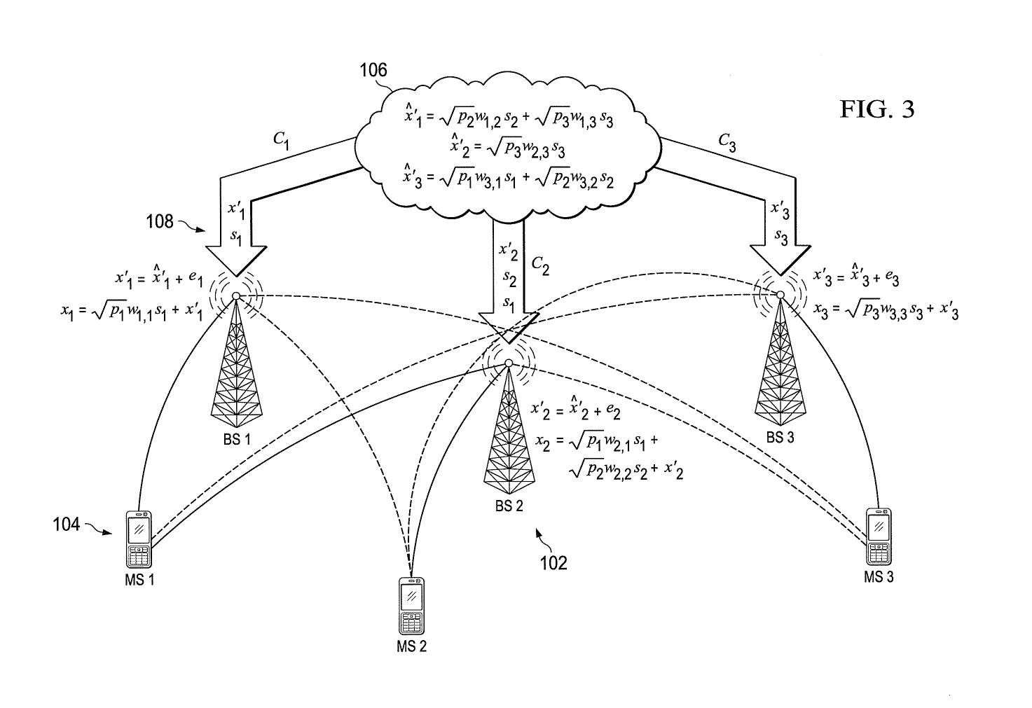

The present disclosure describes an approach as illustrated in FIG. 3 where a part of backhaul capacity is used to send direct messages for some users (for whom the BSs 102 are better off receiving messages directly, instead of their contributions in the compressed pre-coded signals) and the remaining backhaul capacity is used to carry the compressed signal that combines the contributions from the rest of the users. Typically, each BS 102 receives direct messages for the strong users and compressed pre-coded signals combining messages of the rest of the weak users in the network. Each BS 102 then combines the direct messages with the decompressed signal, and transmits the resulting pre-coded signal on its antenna. Note that the appropriate beamforming coefficients are assumed to be available at both the cloud processor 106 and at the BSs 102.

The present disclosure describes a hybrid compression and message-sharing process. The optimization of the hybrid process involves the choice of beamforming vector wₖ, power pₖ, the quantization noise levels qₗ, and the decision of which users should participate in message sharing and which users should participate in compression. To simplify the overall problem, the network wide beamformers are fixed throughout in the present disclosure, however optimization algorithm in which the beamformers are updated throughout is also possible. The design process in the present disclosure begins with an optimized pure compression scheme. At each iteration of the process, the most suitable user for message sharing is selected, then the quantization noise levels are re-optimized for the remaining compressed part. This procedure can be continued until no additional users can benefit from message sharing instead of being included in the compressed signal.

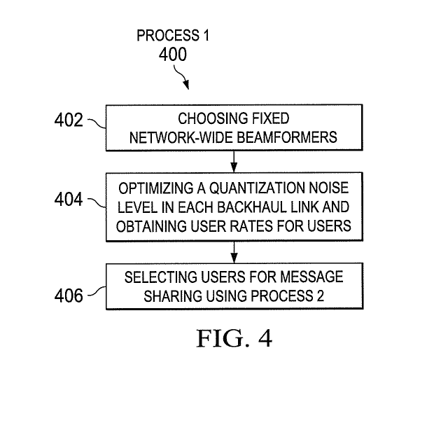

The overall process of hybrid compression and message sharing is described in Process 1 400 illustrated by the flow diagram of FIG. 4. Process 1 400 comprises choosing fixed network-wide beamformers, at 402. The fixed network-wide beamformers may be chosen using, for example, the regularized zero-forcing approach. Process 1 comprises, assuming pure compression, optimizing a quantization noise level in each backhaul link and obtaining user rates for users, at 404. Process 1 comprises using Process 2 to select users for message sharing, at 406. Process 2 is described in further detail below. Each of the components of Process 1 is described in more detail below.

### A. Choose Fixed Network Beamformers

For simplicity, the network beamformers are fixed for pre-coding the user signals over the multiple BSs. An approach is described based on regularized zero-forcing beamforming. The beamformers can also be chosen in different ways, for example using the zero-forcing or the weighted minimum mean square error (WMMSE) approach.

The direction for the beamformer of user k, wₖ, is chosen to be

$$\frac{{t}_{k}}{‖ {t}_{k} ‖}$$

for tₗε [symbol] ^{L×1}, where ┌t₁, . . . , tₖ┐=H^{H}(HH^{H}+αI)⁻¹, Hε [symbol] ^{K×L}=[h₁, . . . , hₖ]^{H}, I is a K×K identity matrix, and α is a regularization factor. The regularization factor α and the powers pₖ associated with each beam are chosen as follows. First, the SINR is approximated for each user by ignoring the residual interference from the other users. Then for a fixed α, the powers pₖ associated with each beam can be chosen to maximize the weighted sum rate by solving the following convex optimization problem (P2) subject to the per-BS power constraints:

$${maximize}_{{p}_{k}} {\sum }_{k = 1}^{K} {μ}_{k} log ( 1 + \frac{{p}_{k} {\vert {h}_{k}^{H} {w}_{k} \vert}^{2}}{{σ}^{2}} )$$

$$subject to {\sum }_{k = 1}^{K} {p}_{k} {\vert {w}_{l , k} \vert}^{2} \leq {P}_{l} , 1 \leq l \leq L$$

$${p}_{k} \geq 0 , 1 \leq k \leq K . \\ ( optimization problem ( P 2 ) )$$

The appropriate regularization constant α can be set heuristically depending on SNR, or it can be found by solving (P2) for different α's and the one that maximizes the weighted sum rate can be selected.

### B. Optimize Pure Compression Scheme

The present disclosure starts with the pure compression strategy, and uses the following method for finding the optimal quantization noise level and the resulting achievable user rates with pure compression. This is akin to solving the optimization problem (P1) above. For simplicity of presentation, the present disclosure assumes that the beamformers wₖ and the powers pₖ are fixed, and optimizes over the quantization noise levels at each BS qₗ, or equivalently Cₗ, as follows:

$${maximize}_{{C}_{l}} {\sum }_{k = 1}^{K} {μ}_{k} log ( 1 + {SINR}_{k}^{′} ) \\ subject to {\sum }_{l = 1}^{L} {C}_{l} \leq C \\ ( optimization problem ( P 3 ) ) , where \\ {SINR}_{k}^{′} = \frac{{p}_{k} {\vert {h}_{k}^{H} {w}_{k} \vert}^{2}}{{\sum }_{j \neq k} {p}_{j} {\vert {h}_{k}^{H} {w}_{j} \vert}^{2} + {σ}^{2} + {\sum }_{l = 1}^{L} \frac{{\hat{P}}_{l} {\vert {h}_{l , k} \vert}^{2}}{{2}^{{C}_{l} - 1}}} \qquad ( equation 1 )$$

The problem is reformulated in terms of C₁ by the substitution

$${q}_{l} = \frac{{\hat{P}}_{l}}{{2}^{{C}_{l}} - 1} .$$

One observation is that the resulting optimization problem (P3) becomes convex in Cₗ (assuming fixed pₖ and wₖ), which allows efficient numerical solution. The proof of concavity is omitted here for brevity.

The variable \hat{P}ₗ above denotes the power of \hat{x}ₗ to be compressed, and is assumed to be a constant in the SINR equation (1) above. Ideally, \hat{P}ₗ should be set as close to the BS power constraint Pₗ as possible. But if \hat{P}ₗ is set exactly equal to Pₗ, after adding quantization noise, the resulting power of the signal transmitted by BS l would exceed the power constraint. For simplicity, the present disclosure starts with \hat{P}ₗ=Pₗ and decrements \hat{P}ₗ by the quantization noise level qₗ after the optimization. This process may need to be iterated until a feasible power allocation satisfying \hat{P}ₗ+qₗ≦Pₗ is found.

### C. Greedy User Selection for Message Sharing

The initial user rates obtained with pure compression are improved upon by allowing the messages for a subset of users to be sent to BSs 102 directly through the backhaul links 108. To select users for direct data transfer, the present disclosure compares, for each user, the backhaul capacity required for sending its message directly, with the reduction in backhaul in compressing the rest of the signal if that user is dropped from compression.

To illustrate this more clearly, recall that the pre-coded signal \hat{x}ₗ=\sqrt{p₁}w_{l,1}s₁+\sqrt{p₂}w_{l,2}s₂+ . . . +\sqrt{p_{K}}w_{l,K}s_{K} is compressed for BS l. The amount of backhaul needed to compress xₗ to within quantization noise level q₁ is approximately

$$log ( \frac{{\hat{P}}_{l}}{{q}_{l}} ) ,$$

where \hat{P}ₗ=p₁|w_{l,1}|²+p₂|w_{l,2}|²+ . . . +p_{K}|w_{l,K}|². Let \hat{P}_{i,j}=pⱼ|w_{i,j}|². If the message for user k is sent directly, the signal that needs to be compressed now has smaller power \hat{P}ₗ−\hat{P}_{l,K}. To compress the signal to within the same quantization noise level qₗ, approximately

$$log ( \frac{{\hat{P}}_{l} - {\hat{P}}_{l , k}}{{q}_{l}} )$$

bits are needed instead. The backhaul capacity needed to send the message of user k to BS l is just its achievable rate, namely, Rₖ. Thus, message sharing is beneficial for user k on BS l whenever Rₖ is less than the saving in the quantization bits, or equivalently

$$log ( \frac{{\hat{P}}_{l}}{{\hat{P}}_{l} - {\hat{P}}_{l , k}} ) - {R}_{k} > 0.$$

This criterion is used to select users for message sharing.

Once a user is selected for message sharing, the quantization noise levels are re-optimized for the compressed part of the signals for each BS again by solving optimization problem (P3) above with a modified total backhaul constraint and modified power constraint. The modified backhaul capacity constraint depends on the rate of the selected user, which is a function of the quantization noise levels to be optimized. Hence, optimization problem (P3) is iteratively solved assuming fixed rate for that user from the previous iteration, then the rate is updated and the process is continued until the rate converges. It will be appreciated that the new quantization noise levels obtained from re-solving optimization problem (P3) also affect the power constraint. However, such effects are small and can be neglected.

Process 2 summarizes the user selection process for message sharing based on the criterion of the equation

$$log ( \frac{{\hat{P}}_{l}}{{\hat{P}}_{l} - {\hat{P}}_{l , k}} ) - {R}_{k} > 0$$

described above. A greedy approach is used to look for the user which can provide the best improvement in backhaul utilization, then the process is continued until no more users would result in further improvement.

```
Process 2: Select Users for Message Sharing
Set nₖ = 0, ∀k; set Cₜₑₘₚ = C;
$Set {g}_{l , k} = log ( \frac{{\hat{P}}_{l}}{{\hat{P}}_{l} - {\hat{P}}_{l , k}} ) - {R}_{k} , ∀ ( l , k )$
Set g = max_{l,k}{g_{l,k}};
while g > 0 do
  Set (\hat{l}, \hat{k}) = arg max g_{l,k} for message sharing;
  Set \hat{P}_{\hat{l}} = \hat{P}_{\hat{l}} − \hat{P}_{\hat{l},\hat{k}}; \hat{P}_{\hat{l},\hat{k}} = 0; nₖ = nₖ + 1.
  repeat
    Set C = Cₜₑₘₚ − Σₖ₌₁^{K} nₖRₖ, and solve (P3)
    Update user rates Rₖ;
  until user rates converge
  $Set {g}_{l , k} = log ( \frac{{\hat{P}}_{l}}{{\hat{P}}_{l} - {\hat{P}}_{l , k}} ) - {R}_{k} , ∀ ( l , k )$
  Set g = max_{l,k}{g_{l,k}};
end while
```

As an alternative algorithm, the selection of which users to perform data-sharing and which users to perform compression may be determined based on channel condition or user location. The optimization algorithm can include the maximization of the weighted sum rate over the beamforming vectors and quantization.

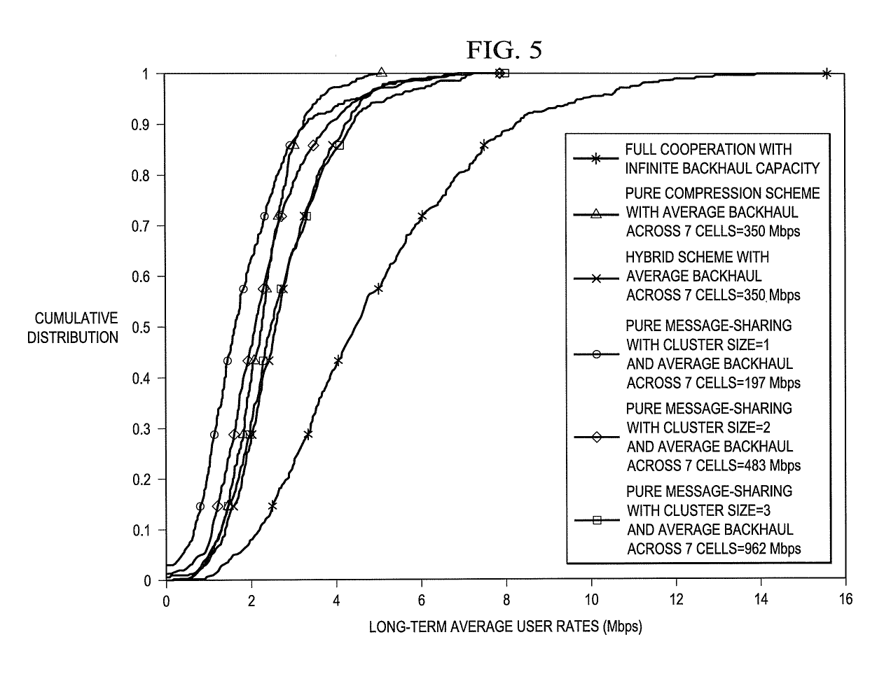

FIGS. 5-7 illustrate simulation results comparing pure compression, pure message-sharing, and the hybrid schemes for a 7-cell CRAM with 15 users randomly located in each cell. Users are scheduled in a round-robin fashion with one active user scheduled per cell at any given time. The BS-to-BS distance is set at 0.8 km, and the noise power spectral density is −162 dBm/Hz. The channels from the BSs to the users are generated according to a distance-dependent path-loss model PL(dB)=128.1+37.1 log 10(d) with 8 dB log-normal shadowing and a Rayleigh fading component, where d is the distance between the BS to the user in km. Perfect channel estimation is assumed, and the CSI is made available to all the BSs and to the centralized processor. A total bandwidth of 10 MHz is assumed.

For simplicity of designing beamformers for message sharing, a sum power constraint over 7 BSs is adopted so that the average power spectral density at each BS antenna is −27 dBm/Hz. For the pure message sharing scheme, cooperation cluster size is fixed for each user, the BSs are picked according to channel strength, and the WMMSE approach is used for designing beamformers. The backhaul capacity is calculated once the user rates are determined. For compression and hybrid schemes, the initial network-wide beamformers are chosen using the WMMSE approach with full cooperation over 7 cells.

FIG. 5 illustrates the cumulative distribution function (CDF) of the user rates for the pure compression, pure message-sharing, and the hybrid schemes. In the simulation, weighted sum rate maximization is used as the optimization objective with weights updated according to proportional fairness criterion. It can be seen that both the pure compression and the hybrid schemes significantly outperform the message-sharing scheme. In particular, the hybrid scheme with 350 Mbps backhaul achieves about the same user rates as the message-sharing scheme with 862 Mbps, which represents a saving in backhaul capacity by about 60%. Further, the hybrid scheme is also seen to outperform the pure compression-based scheme, improving the rate of the 50th percentile user by about 10% at the same backhaul.

In a second set of simulations, a larger network with 19 cells, 3 sectors per cell, and 10 users randomly located in each sector is considered. The central 7 BSs (i.e., the central sectors) form a cooperation cluster. The out-of-cluster interference produced by the rest of BSs is taken into account. A more realistic per-BS power constraint equivalent to −27 dBm/Hz over 10 MHz is imposed, and regularized zero-forcing with per-BS power constraint is used to find the initial beamformers in compression and hybrid designs.

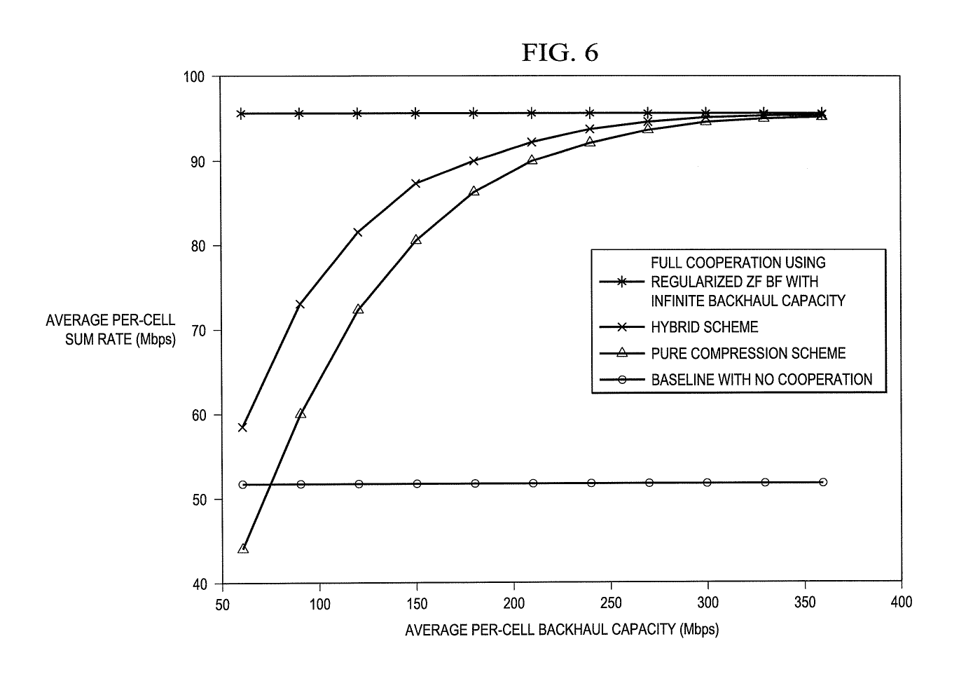

FIG. 6 shows the average per-cell sum rate of the hybrid scheme as compared to the compression-based scheme as a function of average per-cell backhaul capacity. As can be seen from FIG. 6, the hybrid scheme improves backhaul utilization as compared to the compression scheme. The improvement is prominent when the backhaul capacity is small and the gap decreases as the backhaul capacity increases. The maximum achievable rate with infinite backhaul capacity using regularized zero-forcing beamforming and the no-cooperation baseline are also plotted for reference. It can be seen that at an operating point of 85 Mbps per-cell sum rate, which is about 90% of the full cooperation rate, the hybrid scheme requires a backhaul of 150 Mbps, while the pure compression scheme requires 180 Mbps. Thus, the hybrid scheme achieves a saving of about 20% in backhaul capacity requirement.

In order to visualize the improvement in network utility, the total backhaul capacity, in this example, is fixed to be 150 Mbps and 90 Mbps and the CDF of user rates of the compression and the hybrid schemes is plotted and illustrated in FIG. 7. The hybrid scheme is seen to improve over the pure compression scheme mostly for high-rate users.

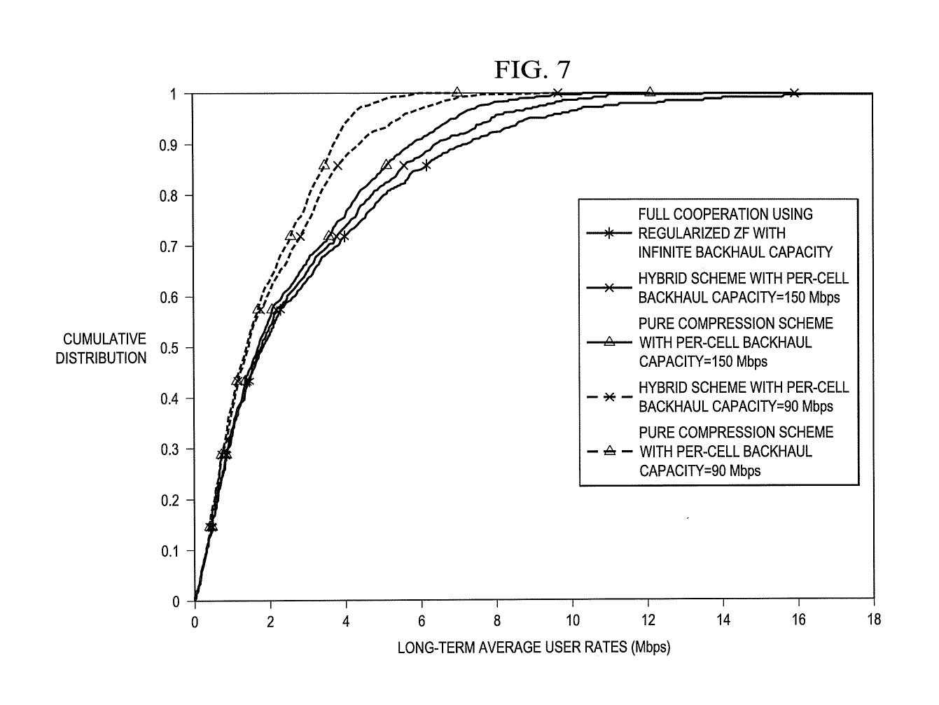

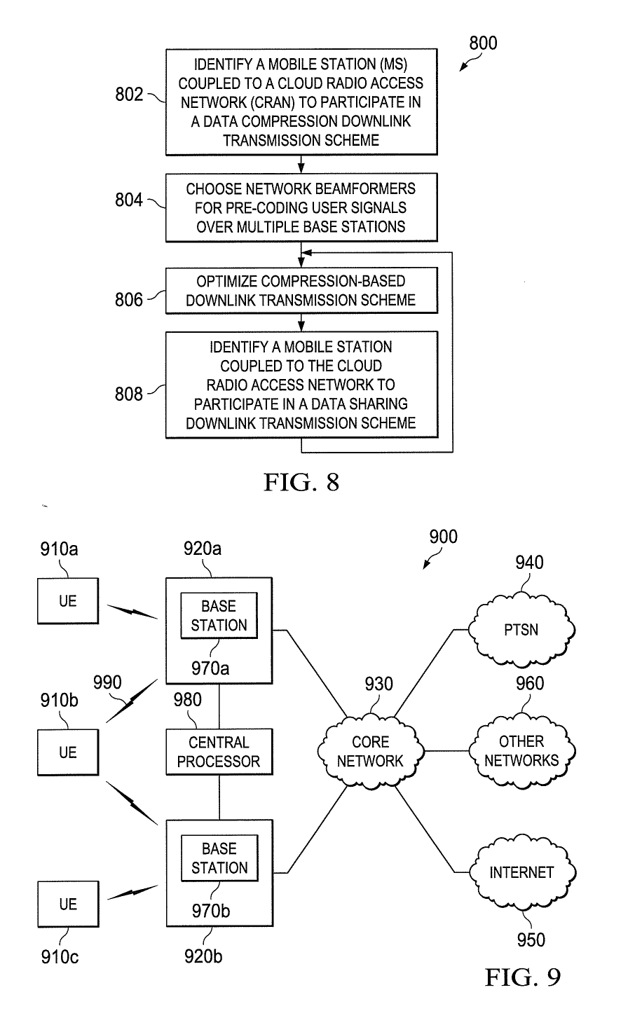

FIG. 8 illustrates a flow diagram illustrating a method 800 of downlink transmission in a cloud radio access network (CRAN) architecture. A mobile station (MS) coupled to the CRAN is identified by the central processor to participate in a data compression downlink transmission scheme, at 802. For example, network beamformers are chosen, at 804, for pre-coding user signals over multiple base stations in the CRAN and a compression-based downlink transmission scheme is used.

Thereafter, the compression-based downlink transmission scheme is optimized, at 806, where an MS coupled to the CRAN is selected, and for the selected MS, user data rates are calculated. The user data rates are calculated by determining an allocation of backhaul capacities across all base stations of the CRAN, determining corresponding quantization noise levels, and determining achievable user data rates for the data compression downlink transmission scheme.

The method comprises identifying, at the central processor, an MS coupled to the CRAN to participate in a data sharing downlink transmission scheme, at 808. For example, an MS that is participating in the data compression downlink transmission scheme is identified to participate in the data sharing downlink transmission scheme to improve the achievable user data rates determined for the data compression downlink transmission scheme.

To illustrate, messages for a subset of selected MSs are sent to at least one of the BSs directly through at least one corresponding backhaul link that couples the BS to the central processor. For each MS of the subset of the selected MSs, a backhaul capacity needed for sending its message directly through the backhaul links is determined. A reduction in backhaul capacity needed for compression by removing the MS from the data compression downlink transmission scheme is determined, and the user data rate for the MS is re-calculated to generate an updated user data rate. The determined backhaul capacity needed for sending the message directly through the backhaul links is compared to the determined reduction in backhaul capacity and, based on the comparison, a determination is made whether to add the MS to the data sharing downlink transmission scheme. After the MS is added to the data sharing downlink transmission scheme, the data compression downlink transmission scheme is re-optimized. Additional MSs may be selected; the user-selection process runs iteratively until convergence.

Data is transmitted to the MS identified to participate in the data compression downlink transmission scheme, and data is transmitted to the MS identified to participate in the data sharing downlink transmission scheme

The above identified methods/flows and devices may be incorporated into a wireless or wired, or combination thereof, communications network and implemented in devices, such as that described below, and in the drawings below.

FIG. 9 illustrates an example communication system 100 for downlink transmission in a CRAM according to one embodiment of this disclosure. In general, the system 900 enables multiple wireless users to transmit and receive data and other content. The system 900 may implement one or more channel access methods, such as code division multiple access (CDMA), time division multiple access (TDMA), frequency division multiple access (FDMA), orthogonal FDMA (OFDMA), or single-carrier FDMA (SC-FDMA).

In this example, the communication system 900 includes user equipment (UE) 910a-910c, radio access networks (RANs) 920a-920b, a core network 930, a public switched telephone network (PSTN) 940, the Internet 950, and other networks 960. While certain numbers of these components or elements are shown in FIG. 9, any number of these components or elements may be included in the system 900.

The UEs 910a-910c are configured to operate and/or communicate in the system 900. For example, the UEs 910a-910c are configured to transmit and/or receive wireless signals or wired signals. Each UE 910a-910c represents any suitable end user device and may include such devices (or may be referred to) as a user equipment/device (UE), wireless transmit/receive unit (WTRU), mobile station (MS), fixed or mobile subscriber unit, pager, cellular telephone, personal digital assistant (PDA), smartphone, laptop, computer, touchpad, wireless sensor, or consumer electronics device. The UEs 910a-910c may correspond to the MSs 104.

The RANs 920a-920b here include base stations 970a-970b, respectively. Each base station 970a-970b is configured to wirelessly interface with one or more of the UEs 910a-910c to enable access to the core network 930, the PSTN 940, the Internet 950, and/or the other networks 960. For example, the base stations 970a-970b may include (or be) one or more of several well-known devices, such as a base transceiver station (BTS), a Node-B (NodeB), an evolved NodeB (eNodeB), a Home NodeB, a Home eNodeB, a site controller, an access point (AP), or a wireless router, or a server, router, switch, or other processing entity with a wired or wireless network.

In the embodiment shown in FIG. 9, the base station 970a forms part of the RAN 920a, which may include other base stations, elements, and/or devices. Also, the base station 970b forms part of the RAN 920b, which may include other base stations, elements, and/or devices. Each base station 970a-970b operates to transmit and/or receive wireless signals within a particular geographic region or area, sometimes referred to as a “cell.” In some embodiments, multiple-input multiple-output (MIMO) technology may be employed having multiple transceivers for each cell.

The base stations 970a-970b communicate with one or more of the UEs 910a-910c over one or more air interfaces 990 using wireless communication links. The air interfaces 990 may utilize any suitable radio access technology.

It is contemplated that the system 900 may use multiple channel access functionality, including such schemes as described above. In particular embodiments, the base stations and UEs implement LTE, LTE-A, and/or LTE-B. Of course, other multiple access schemes and wireless protocols may be utilized.

The RANs 920a-920b are in communication with the core network 930 to provide the UEs 910a-910c with voice, data, application, Voice over Internet Protocol (VoIP), or other services. Understandably, the RANs 920a-920b and/or the core network 930 may be in direct or indirect communication with one or more other RANs (not shown). The core network 930 may also serve as a gateway access for other networks (such as PSTN 940, Internet 950, and other networks 960). In addition, some or all of the UEs 910a-910c may include functionality for communicating with different wireless networks over different wireless links using different wireless technologies and/or protocols.

Although FIG. 9 illustrates one example of a communication system, various changes may be made to FIG. 9. For example, the communication system 900 could include any number of UEs, base stations, networks, or other components in any suitable configuration, and can further include the EPC illustrated in any of the figures herein.

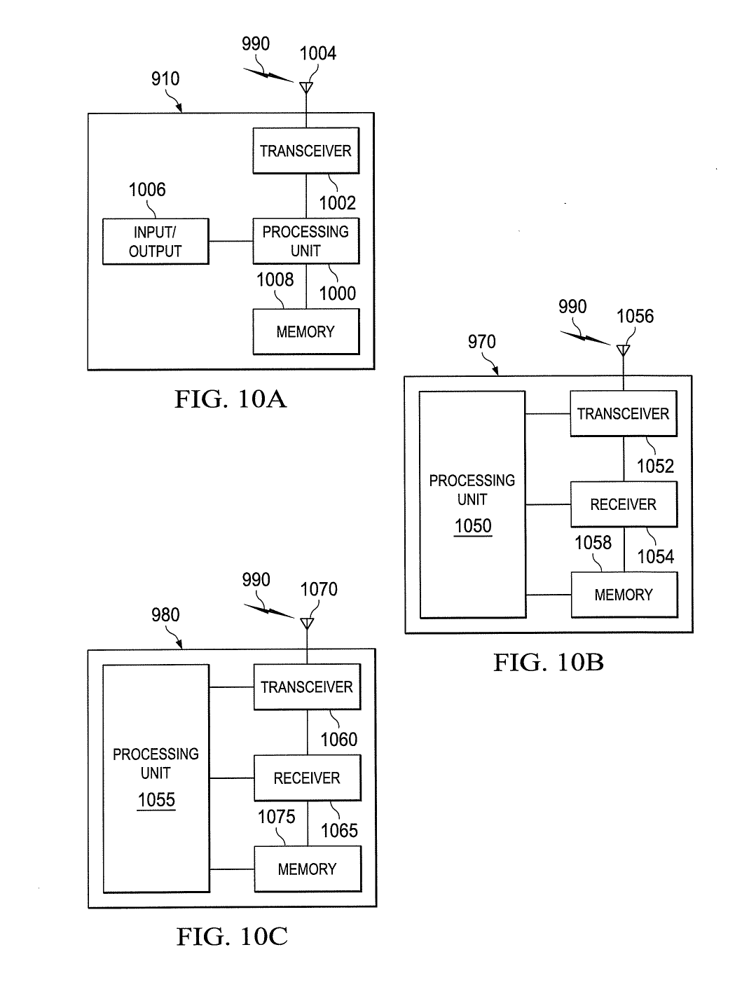

FIGS. 10A, 10B and 10C illustrate example devices that may implement the methods and teachings according to this disclosure. In particular, FIG. 10A illustrates an example UE 910, FIG. 10B illustrates an example base station 970, and FIG. 10C illustrates an example central processor 906. These components could be used in the system 900 or in any other suitable system.

As shown in FIG. 10A, the UE 910 includes at least one processing unit 1000. The processing unit 1000 implements various processing operations of the UE 910. For example, the processing unit 1000 could perform signal coding, data processing, power control, input/output processing, or any other functionality enabling the UE 910 to operate in the system 900. The processing unit 1000 also supports the methods and teachings described in more detail above. Each processing unit 1000 includes any suitable processing or computing device configured to perform one or more operations. Each processing unit 1000 could, for example, include a microprocessor, microcontroller, digital signal processor, field programmable gate array, or application specific integrated circuit.

The UE 910 also includes at least one transceiver 1002. The transceiver 1002 is configured to modulate data or other content for transmission by at least one antenna 1004. The transceiver 1002 is also configured to demodulate data or other content received by the at least one antenna 1004. Each transceiver 1002 includes any suitable structure for generating signals for wireless transmission and/or processing signals received wirelessly. Each antenna 1004 includes any suitable structure for transmitting and/or receiving wireless signals. One or multiple transceivers 1002 could be used in the UE 910, and one or multiple antennas 1004 could be used in the UE 910. Although shown as a single functional unit, a transceiver 1002 could also be implemented using at least one transmitter and at least one separate receiver.

The UE 910 further includes one or more input/output devices 1006. The input/output devices 1006 facilitate interaction with a user. Each input/output device 1006 includes any suitable structure for providing information to or receiving information from a user, such as a speaker, microphone, keypad, keyboard, display, or touch screen.

In addition, the UE 910 includes at least one memory 1008. The memory 1008 stores instructions and data used, generated, or collected by the UE 910. For example, the memory 908 could store software or firmware instructions executed by the processing unit(s) 1000 and data used to reduce or eliminate interference in incoming signals. Each memory 1008 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 10B, the base station 970 includes at least one processing unit 1050, at least one transmitter 1052, at least one receiver 1054, one or more antennas 1056, and at least one memory 1058. The processing unit 1050 implements various processing operations of the base station 970, such as signal coding, data processing, power control, input/output processing, or any other functionality. The processing unit 1050 can also support the methods and teachings described in more detail above. Each processing unit 1050 includes any suitable processing or computing device configured to perform one or more operations. Each processing unit 1050 could, for example, include a microprocessor, microcontroller, digital signal processor, field programmable gate array, or application specific integrated circuit.

Each transmitter 1052 includes any suitable structure for generating signals for wireless transmission to one or more UEs or other devices. Each receiver 1054 includes any suitable structure for processing signals received wirelessly from one or more UEs or other devices. Although shown as separate components, at least one transmitter 1052 and at least one receiver 1054 could be combined into a transceiver. Each antenna 1056 includes any suitable structure for transmitting and/or receiving wireless signals. While a common antenna 1056 is shown here as being coupled to both the transmitter 1052 and the receiver 1054, one or more antennas 1056 could be coupled to the transmitter(s) 1052, and one or more separate antennas 1056 could be coupled to the receiver(s) 1054. Each memory 1058 includes any suitable volatile and/or non-volatile storage and retrieval device(s).

As shown in FIG. 10C, the central processor 980 includes at least one processing unit 1055, at least one transmitter 1060, at least one receiver 1065, one or more antennas 1070, and at least one memory 1075. The processing unit 1055 implements various processing operations of the central processor 980, such as signal coding, data processing, power control, input/output processing, or any other functionality. The processing unit 1055 can also support the methods and teachings described in more detail above. Each processing unit 1055 includes any suitable processing or computing device configured to perform one or more operations. Each processing unit 1055 could, for example, include a microprocessor, microcontroller, digital signal processor, field programmable gate array, or application specific integrated circuit.

Each transmitter 1060 includes any suitable structure for generating signals for wireless transmission to one or more UEs or other devices. Each receiver 1065 includes any suitable structure for processing signals received wirelessly from one or more UEs or other devices. Although shown as separate components, at least one transmitter 1060 and at least one receiver 1065 could be combined into a transceiver. Each antenna 1070 includes any suitable structure for transmitting and/or receiving wireless signals. While a common antenna 1070 is shown here as being coupled to both the transmitter 1060 and the receiver 1065, one or more antennas 1070 could be coupled to the transmitter(s) 1060, and one or more separate antennas 1070 could be coupled to the receiver(s) 1065. Each memory 1075 includes any suitable volatile and/or non-volatile storage and retrieval device(s).

Additional details regarding UEs 910, base stations 970, and central processor 980 are known to those of skill in the art. As such, these details are omitted here for clarity.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of downlink transmission in a cloud radio access network (CRAN), the method performed by a data processing system and comprising:
identifying, by the data processing system, a mobile station (MS) coupled to the CRAN to participate in a data compression downlink transmission scheme; and
identifying, by the data processing system, an MS coupled to the CRAN to participate in a data sharing downlink transmission scheme.

2. The method according to claim 1, wherein the identified MS for participating in the compression downlink transmission scheme is different from the identified MS for participating in the data sharing downlink transmission scheme.

3. The method according to claim 1, further comprising identifying beamformers across multiple base stations (BSs) of the CRAN for pre-coding user signals over the multiple BSs.

4. The method according to claim 3, wherein identifying the MS coupled to the CRAN to participate in a data compression downlink transmission scheme comprises:
selecting an MS;
for the selected MS, calculating user data rates comprising:
determining an allocation of backhaul capacities across all BSs of the CRAN,
determining corresponding quantization noise levels, and
determining achievable user data rates for the data compression downlink transmission scheme.

5. The method according to claim 4, wherein identifying an MS coupled to the CRAN to participate in a data sharing downlink transmission scheme comprises:
identifying an MS that is participating in the data compression downlink transmission scheme to participate in the data sharing downlink transmission scheme to improve the achievable user data rates determined for the data compression downlink transmission scheme.

6. The method according to claim 5, wherein identifying an MS to participate in the data sharing downlink transmission scheme comprises:
sending messages for a subset of selected MSs to at least one of the BSs directly through at least one corresponding backhaul link that couples the BS to a central processor.

7. The method according to claim 6, further comprising:
determining, for each MS of the subset of the selected MSs, a backhaul capacity needed for sending its message directly through the backhaul links;
determining, for each MS of the subset of the selected MSs, a reduction in backhaul capacity needed for compression by removing the MS from the data compression downlink transmission scheme and re-calculating the user data rates for the MS to generate an updated user data rate;
comparing the determined backhaul capacity needed for sending the message directly through the backhaul links to the determined reduction in backhaul capacity; and
based on the comparison, determining whether to add the MS to the data sharing downlink transmission scheme.

8. The method according to claim 7, further comprising:
transmitting data to the MS identified to participate in the data compression downlink transmission scheme; and
transmitting data to the MS identified to participate in the data sharing downlink transmission scheme.

9. The method according to claim 7, wherein the reduction in backhaul capacity is determined for each MS of the subset of the selected MSs by performing a sequential search of each MS of the subset.

10. The method according to claim 7, wherein the reduction in backhaul capacity is determined for each MS of the subset of the selected MSs by performing a greedy search of the MSs of the subset.

11. The method according to claim 3, further comprising utilizing a zero forcing process or a weighted minimum mean square error (WMMSE) process to identify the beamformers.

12. A data processing system for downlink transmission in a cloud radio access network (CRAN), the data processing system comprising:
a processor; and
memory coupled to the processor comprising instructions that, when executed by the processor, cause the data processing system to perform operations comprising:
identifying a mobile station (MS) coupled to the CRAN to participate in a data compression downlink transmission scheme; and
identifying an MS coupled to the CRAN to participate in a data sharing downlink transmission scheme.

13. The data processing system according to claim 12, wherein the identified MS for participating in the compression downlink transmission scheme is different from the identified MS for participating in the data sharing downlink transmission scheme.

14. The data processing system in accordance with claim 12 further comprising instructions that, when executed by the processor, cause the data processing system to perform operations comprising identifying beamformers across multiple base stations (BSs) of the CRAN for pre-coding user signals over the multiple BSs.

15. The data processing system in accordance with claim 14, wherein identifying the MS coupled to the CRAN to participate in a data compression downlink transmission scheme comprises:
selecting an MS;
for the selected MS, calculating user data rates comprising:
determining an allocation of backhaul capacities across all BSs of the CRAN,
determining corresponding quantization noise levels, and
determining achievable user data rates for the data compression downlink transmission scheme.

16. The data processing system in accordance with claim 15, wherein identifying an MS coupled to the CRAN to participate in a data sharing downlink transmission scheme comprises:
identifying an MS that is participating in the data compression downlink transmission scheme to participate in the data sharing downlink transmission scheme to improve the achievable user data rates determined for the data compression downlink transmission scheme.

17. The data processing system in accordance with claim 15, wherein identifying an MS to participate in the data sharing downlink transmission scheme comprises:
sending messages for a subset of selected MSs to at least one of the BSs directly through at least one corresponding backhaul link that couples the BS to a central processor.

18. The data processing system in accordance with claim 17, further comprising instructions that, when executed by the processor, cause the data processing system to perform operations comprising:
determining, for each MS of the subset of the selected MSs, a backhaul capacity needed for sending its message directly through the backhaul links;
determining, for each MS of the subset of the selected MSs, a reduction in backhaul capacity needed for compression by removing the MS from the data compression downlink transmission scheme and re-calculating the user data rates for the MS to generate an updated user data rate;
comparing the determined backhaul capacity needed for sending the message directly through the backhaul links to the determined reduction in backhaul capacity; and
based on the comparison, determining whether to add the MS to the data sharing downlink transmission scheme.

19. The data processing system in accordance with claim 18, further comprising instructions that, when executed by the processor, cause the data processing system to perform operations comprising:
transmitting data to the MS identified to participate in the data compression downlink transmission scheme; and
transmitting data to the MS identified to participate in the data sharing downlink transmission scheme.

20. The data processing system in accordance with claim 18, wherein the reduction in backhaul capacity is determined for each MS of the subset of the selected MSs by performing a sequential search of each MS of the subset.

21. The data processing system in accordance with claim 18, wherein the reduction in backhaul capacity is determined for each MS of the subset of the selected MSs by performing a greedy search of the MSs of the subset.

22. The data processing system in accordance with claim 14, further comprising instructions that, when executed by the processor, cause the data processing system to perform operations comprising utilizing a zero forcing process or a weighted minimum mean square error (WMMSE) process to identify the beamformers.
